(19) United States
(12) Patent Application Publication
(10) Pub. No.: US 2026/0159359 A1
(43) Pub. Date: Jun. 11, 2026

(54) RAIL SYSTEM FOR AN ELEVATOR INSTALLATION AND METHOD FOR PRODUCING SUCH A RAIL SYSTEM

(71) Applicant: Inventio AG, Hergiswil (CH)

(72) Inventors: Stefan Weber, Niederwil AG (CH); Andre Weibel, Ballwil (CH); Stephan Hess, Emmenbrucke (CH)

(21) Appl. No.: 18/707,647

(22) PCT Filed: Oct. 25, 2022
(86) PCT No.: PCT/EP2022/079748

§ 371 Date: May 6, 2024

(30) Foreign Application Priority Data
Nov. 12, 2021 (EP) 21207947.9

(51) Int. Cl. B66B 19/00

(52) U.S. Cl. CPC B66B 19/002

(57) ABSTRACT

A rail system for an elevator system has at least one vertically aligned rail for guiding vertically movable components of the elevator system, wherein the rail is anchored to at least one substantially vertically aligned wall at different height positions using anchoring devices. The rail bridges interspaces between adjacent ones of the anchoring devices, wherein the interspaces vary at least within a section of the rail depending on a local load on the rail, and the lengths of the interspaces within the section vary in a monotonically decreasing manner depending on a dead weight of the rail arranged locally above.

### FIELD

The present invention relates to a rail system for an elevator system and to a method for producing such a rail system.

### BACKGROUND

An elevator system can have vertically movable components such as a car and a counterweight to the car. The vertically movable components can be guided through a rail system of the elevator system. The rail system thereby prevents lateral movements of the vertically movable components. The vertically movable components can be moved along vertical rails of the rail system by a drive device.

The rails can run, for example, within an elevator shaft of the building. The rails can be connected to walls of the elevator shaft by anchoring devices of the rail system. The anchoring devices can be referred to as rail clamps or brackets. The anchoring devices can be arranged at regular intervals along the rail. By means of regular anchoring devices along the rail, a drill gauge, for example, can be used in order to be able to exactly maintain the distances when installing the anchoring devices.

JP 2013 151 336 A, JP S55 74980 A, EP 3 118151 A1, EP 2 516 311 A1 and JP 2021 147 118 A show arrangements of anchoring devices in the shaft.

The distances between the anchoring devices are constant over the entire rail system. The employed distance is designed for a maximum load on the rail.

### SUMMARY

Among other things, there can be a need for a rail system with improved properties, in particular for example improved material utilization.

Such a need can be met by a rail system for an elevator system and a method for producing such a rail system according to the advantageous embodiments defined and described in the description.

The rail is not subjected to the same load everywhere or is not subjected to the maximum load everywhere. A conventional rail system therefore has too many anchoring devices at locations that are subjected to a smaller load. In the approach presented here, the interspaces between the anchoring devices are adapted to the actual load. Fewer anchoring devices can thereby be used. Due to the approach presented here, the material requirement for the anchoring devices of the rail system can be reduced by up to 25 percent.

According to one aspect of the invention, a rail system for an elevator system is presented, wherein the rail system has at least one vertically aligned rail for guiding vertically movable components of the elevator system, wherein the rail is anchored at different height positions on at least one substantially vertically aligned wall using anchoring devices and bridges interspaces between adjacent anchoring devices, wherein the lengths of the interspaces vary in a monotonically decreasing manner depending on a local load on the rail at least in a section of the rail system.

According to a further aspect of the invention, a method for producing a rail system for an elevator system is presented, wherein the rail system has at least one vertically aligned rail for guiding vertically movable components of the elevator system, wherein the rail is anchored at different height positions, on at least one substantially vertically aligned wall using anchoring devices, and bridges interspaces between adjacent anchoring devices. Wherein the method has the following steps:
calculating varying lengths of the interspaces for at least one section of the rail decreasing monotonically depending on a local load on the rail,
arranging the anchoring devices with the calculated lengths of the interspaces on the wall, and
connecting the rail to the anchoring devices in order to bridge the varying interspaces.

An elevator system can be a passenger transport system. The elevator system can have at least one car which can be moved up and down in the vertical direction along a rail system of the elevator system. The weight of the car can be at least partially compensated for by at least one counterweight. The counterweight can also be moved up and down along the rail system. The car and the counterweight can be connected to one another by support means, such as cables or belts. The support means can be moved by a drive system of the elevator system in order to move the car upward while the counterweight is moved downwards, and vice versa. The drive system can, for example, be arranged at an upper end of the rail system.

The rail system can have at least one vertical rail which extends continuously over the complete elevator system. The rail can, for example, be made of a metal material. The rail can be composed of individual portions. A pit region can be arranged at a lower end of the rail. In the pit region, the rail can be anchored in a foundation of the elevator system. During intended operation of the elevator system, the car can be moved within a travel region of the rail located above the pit region. A buffer for the car can be arranged in the pit region. In buffer travel, the car can move onto the buffer in the pit region.

The rail system can be arranged, for example, within an elevator shaft of a building. The rail system can also be arranged on an outer wall or inner wall of the building. The rail can be connected to the building or the wall via substantially horizontally aligned anchoring devices of the rail system. An anchoring device can be referred to as a rail clamp or bracket. The anchoring devices can be screwed to the building or the wall. An anchoring device can be used for one or more rails of the rail system.

In order to support the rail over the entire movement region, the rail system has a plurality of anchoring devices. The anchoring devices are arranged at different height positions along the rail. Two anchoring devices are each spaced apart from one another by an interspace. The interspace represents a distance between adjacent anchoring devices in the vertical direction.

The anchoring devices here have variable interspaces. The interspaces between pairs of anchoring devices which follow one another in the vertical direction can differ from one another by more than 1%, preferably more than 2%, 5% or even more than 10%. The lengths of the interspaces can thereby substantially depend on a local load on the rail. The lengths of the interspaces can be calculated taking into account the local load. The load can be composed of different forces. The forces can act in the direction of the rail. Likewise, the forces can act transversely and/or obliquely relative to the rail. The load results from a sum of the forces.

The dependence of the length of the interspaces on the local load is monotonically decreasing in this case. Monotonically decreasing describes a property of the function that describes the dependence of the length of the interspaces on the local load. The length of the interspaces decreases monotonically for increasing loads. In other words, the length of the interspaces either decreases for increasing loads or remains at least the same. This applies in particular to the load from the dead weight of the rail arranged above.

The anchoring devices can be fastened to the wall using a drilling robot. At the very least, holes for fastening the anchoring devices can be drilled by the drilling robot. The drilling robot can produce varying interspaces very easily since the drilling head of the drilling robot can be precisely controlled. The drilling robot can precisely drill a completely variable drilling plan with different interspaces adapted to the local load.

The lengths of the interspaces can be smaller at or near a lower end of the section than at or near an upper end of the section. At the lower end of the section, the load can be greater than at the upper end. The lengths of the interspaces can increase from the bottom to the top. Fewer anchoring devices can therefore be used at the upper end than at the lower end. Material can be saved at the upper end by means of fewer anchoring devices.

Alternatively or additionally, anchoring devices adapted to the local load can be used. For example, the anchoring devices can be dimensioned smaller from the bottom to the top. The use of material can also be reduced by the above-dimensioned anchoring devices.

The lengths of the interspaces can vary in steps. In this case, a plurality of successive interspaces can be identical over the section, and then a jump to a larger or smaller interspace can take place. The locally constant interspaces can be adapted to an average local load in the region. The locally constant interspaces can be drilled easily using a drilling template. A different guide of the drilling template can be used for each jump of the interspace. Alternatively, different drilling templates can be used. The dependence of the length of the interspaces on the local load therefore decreases monotonically in steps.

The pit region of the rail system and the mentioned section of the rail system can jointly form more than half the length of the rail system and in particular substantially forms the entire length of the rail system.

The rail system therefore on the one hand substantially consists of the pit region and the section in which the length of the interspaces is varied. On the other hand, the travel region can also comprise further sections. In these sections, the load can, for example, be so small that the length of the interspaces is limited to a maximum value by other conditions, for example the length of a single rail piece. In this section, the length of the interspaces for increasing loads then no longer necessarily decreases monotonically, but changes back and forth, for example, between a greater value and a smaller value. This section preferably comprises less than half the entire rail system.

The lengths of the interspaces can be smaller in the pit region than in the section of the rail system.

Additional anchoring devices can be arranged in the pit region. More anchoring devices can be arranged in the pit region than would be necessary due to the local load. The anchoring devices can have uniform lengths of the interspaces in the pit region. In the pit region, the local load can be increased by seldom occurring lateral loads. The lateral loads can arise, for example, during buffer travel if the car is asymmetrically loaded during the buffer travel. The asymmetrical load results in a torque when the car strikes the buffer arranged centrally in the pit region. This torque acts as a lateral force on the rail and can be diverted into the building or the wall by the additional anchoring devices. Damage to the rail during buffer travel can be reliably avoided by the additional anchoring devices.

The lengths of the interspaces can be monotonically decreasing in the mentioned section depending on a dead weight of the rail arranged locally above. The dead weight of the rail can be the primary factor of the load. Lateral loads can be constant over the section. The rail can slide axially through the anchoring devices. In particular, the rail can slide through the anchoring device when an axial force is greater than a holding force of the anchoring device. The holding force can be smaller than a dead weight of the rail arranged locally above. The rail can weigh 22 kilograms per meter, for example. The rail can slide at 300 to 600 newtons through the anchoring device, which corresponds to a weight of 30 to 60 kilograms. The anchoring device can therefore guide the rail in the horizontal or lateral direction and allow a movement of the rail relative to the anchoring device in the vertical or axial direction. Due to the axial mobility, the rail locally bears its dead weight arranged above, which increases continuously from the top to the bottom. The dead weight can be introduced into the foundation at the lower end of the rail. Due to the vertical mobility, differences in the thermal expansion of the rail and of the building and/or settlement of the building can be compensated for, for example. The dead weight arranged locally above may not be greater than a buckling load. The buckling load can be the load in which the rail bends laterally away in the interspace. The buckling load can therefore comprise the force or load that acts in the direction of the rail. The buckling load is dependent on a free length of the rail between two anchoring devices. The free length corresponds to the interspace. The buckling load can also be dependent on a profile of the rail. The profile can have a preferred bending direction, for example. In the preferred bending direction, the rail has a minimum buckling load. In the formula for the buckling load according to Euler, the permissible buckling load is proportional to the inverse of the free length of the rail between two anchoring devices squared.

The lengths of the interspaces can be inversely proportional to the root of the dead weight arranged locally above. The greater the dead weight arranged above, the smaller the lengths of interspaces can be. Due to an inversely proportional relationship to the root of the dead weight arranged locally above, no interspace is the same in the section of the rail, since the above-arranged dead weight is dependent on the height position of the respective interspace.

It should be noted that some of the possible features and advantages of the invention are described herein with reference to different embodiments of methods on the one hand and of devices on the other hand. A person skilled in the art will recognize that the features can be suitably combined, adapted, or exchanged in order to arrive at further embodiments of the invention.

Embodiments of the invention will be described below with reference to the accompanying drawing, with neither the drawing nor the description being intended to be interpreted as limiting the invention.

### DESCRIPTION OF THE DRAWINGS

FIG. 1 shows an illustration of a rail system according to an embodiment of the invention.

The drawing is merely schematic and not to scale. The same reference signs indicate the same or equivalent features.

### DETAILED DESCRIPTION

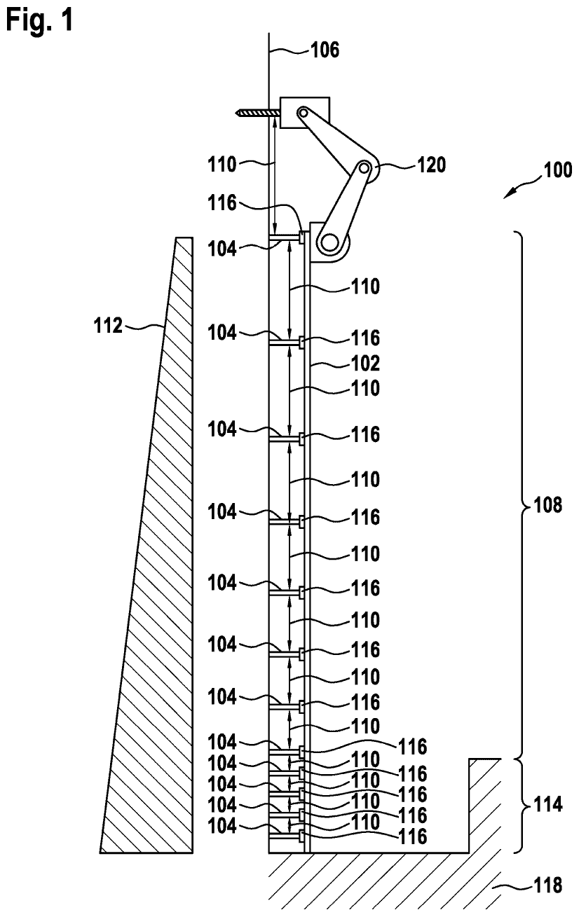

FIG. 1 shows an illustration of a rail system 100 according to an embodiment of the invention. The rail system 100 has at least one vertically aligned rail 102 and a plurality of anchoring devices 104. The anchoring devices 104 connect the rail 102 to at least one wall 106 of a building. The anchoring devices 104 run substantially horizontally between the rail 102 and the wall 106.

In a section 108 of the rail system 100, the anchoring devices 104 are arranged with load-dependent interspaces 110. The interspaces 110 are dependent on a local load 112 on the rail 102. The rail 102 bridges the interspaces 110.

The load 112 is a total force composed of different forces. In this case, the load consists of horizontal forces and vertical forces.

The load 112 increases from the top to the bottom due to a dead weight of the rail 102. A local weight of the rail 102 thereby adds up from all above-arranged portions of the rail 102. Therefore, the interspaces 110 in the section 108 are smaller from the top to the bottom.

In one embodiment, the interspaces 110 in a pit region 114 of the rail system 100 are smaller than in the section 108. In the pit region 114, the interspaces 110 are constant in contrast to the section 108. In the pit region, the interspaces 110 do not change depending on the local load 112. More anchoring devices 104 are arranged in the pit region 114 than would be necessary due to the local load 112.

In one embodiment, the anchoring devices 104 are clamped to the rail 102 using clips 116. If a force in the direction of the rail 102 is greater than a frictional force of the clip 116, the rail 102 slips in the axial direction through the clip 116. Accordingly, settlement movements of the wall 106 are not transferred to the rail 102. Likewise, the rail 102 can shrink or become longer in the event of temperature fluctuations without subjecting the anchoring devices 104 to a load with a shear force greater than the frictional force. The rail 102 is floatingly mounted by the clips 116. The dead weight of the rail 102 rests on a foundation 118 of the rail system 100.

In one embodiment, the anchoring devices 104 are mounted using a robot 120. In this case, the interspaces 110 are calculated depending on the load 112 to be expected, and the robot 120 drills fastening means for the anchoring devices 104 at corresponding intervals into the wall 106. The anchoring devices 104 are then fastened to the wall 106 and aligned, and the rail 102 is connected to the anchoring devices 104.

In other words, in the approach presented here, the spacing of the rail clamps (brackets) is adapted for different loads. Given higher loads on the rails, more brackets, i.e., at a smaller distance, are therefore set.

Until now, the brackets have been installed at the same distance in the entire elevator, except in the pit region. More brackets are often installed there, since extremely large forces are introduced there into the rail during buffer travel.

In the approach presented here, the distance of bracket to bracket increases continuously from bottom to top since the pressure load and therefore the risk of kinking decreases with increasing height. A robot can very precisely maintain a drilling plan. Manually, the same distance would tend to always be maintained.

Unequal fastening heights of the guide rail (HF distance) are presented. Instead of having the same vertical distance between two holders in a shaft over the entire length of the rail, a smaller vertical distance is used in the lower part of the shaft, and a higher vertical distance is used in the upper part of the shaft. It is possible to have three, four or more different vertical distances upward.

This is useful since the buckling load often determines the minimum vertical distance and/or the size of the guide rail. This buckling is critical especially in the lower part of the shaft, since the load acting on the rails increases due to its dead weight toward the shaft pit.

A greater distance in the upper region requires fewer holders, clips, and separators, which leads to lower costs.

Finally, it should be noted that terms such as “having,” “comprising,” etc. do not preclude other elements or steps, and terms such as “a” or “one” do not preclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. A rail system for an elevator system, the rail system comprising:
a vertically aligned rail adapted to guide vertically movable components of the elevator system;
a plurality of anchoring devices anchoring the rail at different height positions on a vertically aligned wall wherein the rail bridges interspaces between adjacent ones of the anchoring devices; and
wherein lengths of the interspaces monotonically decrease depending on a local load on the rail in at least a section of the rail system.

11. The rail system according to claim 10 wherein a pit region of the rail system and the section of the rail system jointly form more than half a length of the rail system.

12. The rail system according to claim 11 wherein a pit region of the rail system and the section of the rail system jointly form an entire length of the rail system.

13. The rail system according to claim 11 wherein the lengths of the interspaces in the pit region are smaller than the lengths of the interspaces in the section of the rail system.

14. The rail system according to claim 10 wherein the lengths of the interspaces monotonically decrease in the section depending on a dead weight of the rail arranged above each of the interspaces.

15. The rail system according to claim 14 wherein the lengths of the interspaces are inversely proportional to a root of the dead weight arranged above.

16. The rail system according to claim 10 wherein the lengths of the interspaces are smaller at a lower end of the section than at an upper end of the section.

17. The rail system according to claim 10 wherein the lengths of the interspaces vary in steps.

18. A method for producing a rail system for an elevator system, wherein the rail system a vertically aligned rail for guiding vertically movable components of the elevator system, wherein the rail is anchored at different height positions on a vertically aligned wall by anchoring devices and the rail bridges interspaces between adjacent ones of the anchoring devices, the method comprising the steps of:
calculating varying lengths for the interspaces in a section of the rail, the decreasing monotonically depending on a local load on the rail at each of the interspaces;
arranging the anchoring devices on the wall at the calculated lengths of the interspaces; and
connecting the rail to the anchoring devices wherein the interspaces are bridged by the rail.

19. The method according to claim 18 wherein the length of each of the interspaces is calculated inversely proportionally to a root of a dead weight of the rail arranged above.

20. The method according to claim 18 further comprising a step of arranging the anchoring devices on the wall using a robot.
